(19) United States
(12) Patent Application Publication
(10) Pub. No.: US 2026/0154987 A1
(43) Pub. Date: Jun. 4, 2026

(54) METHOD FOR AUGMENTING SIGN LANGUAGE POSTURE INFORMATION USING SIGN LANGUAGE VIDEO AND SIGN LANGUAGE MORPHEMES

(71) Applicant: Korea Electronics Technology Institute, Seongnam-si (KR)

(72) Inventors: Han Mu PARK, Seongnam-si (KR); Sang Won LEE, Seoul (KR)

(73) Assignee: Korea Electronics Technology Institute, Seongnam-si (KR)

(21) Appl. No.: 19/398,666

(22) Filed: Nov. 24, 2025

(30) Foreign Application Priority Data
Nov. 29, 2024 (KR) 10-2024-0175504

(51) Int. Cl. G06V 40/20; G06V 10/44; G06V 10/82; G06V 20/40

(52) U.S. Cl. CPC G06V 40/28; G06V 10/44; G06V 10/82; G06V 20/41; G06V 20/46

(57) ABSTRACT

Provided is a sign language posture information augmentation method using a sign language video and sign language morphemes. The sign language posture information augmentation method according to an embodiment may predict 3D sign language posture information from a 2D sign language video stored in a first sign language data set with pre-trained networks, and to augment 3D posture information based on sign language feature information which is extracted by using information of the first sign language data set and the predicted information. Accordingly, new 3D posture information meeting the sign language feature information may be augmented.

### CROSS-REFERENCE TO RELATED APPLICATION(S) AND CLAIM OF PRIORITY

This application is based on and claims priority under 35 U.S.C. § 119 to Korean Patent Application No. 10-2024-0175504, filed on November 29, 2024, in the Korean Intellectual Property Office, the disclosure of which is herein incorporated by reference in its entirety.

### BACKGROUND

### FIELD

The disclosure relates to sign language data set augmentation, and more particularly, to a method for augmenting sign language posture information by using a sign language video and sign language morphemes.

### DESCRIPTION OF RELATED ART

Sign language includes sign language morphemes and non-manual signals, and meanings of sign language vary depending on handshapes, palm orientations, hand locations, hand movements, and facial expressions as well as hands. Therefore, posture information on exact sign language gestures may be needed for sign language gesture recognition and translation. Sign language video data sets may be transformed into two-dimensional (2D) information as sign language gestures in a three-dimensional (3D) space are recorded as a video, and in this case, there may be a negative impact on sign language gesture recognition performance, including ambiguity about depth and occlusion of different parts of the body depending on gestures. In addition, when an input value is a sign language video or an image, the computation of a network increases, which is not suitable for real-time sign language gesture recognition and translation. Therefore, sign language posture information with lower computation may be needed for real-time processing. For the above reasons, 3D posture information is required, but there is a significant shortage of sign language video data sets including 3D posture information. In particular, it may be difficult to collect data enough to train sign language gesture recognition models since sign language video data requires actual deaf people to take videos, and labeling 3D posture information may cause a great cost burden.

Meanwhile, there are physical differences between sign language speakers (shoulder width, knuckle length, etc.), so that the same words and sentences do not have the same 3D posture information. This means that, if various physical characteristics are not considered, subsequent sign language gesture recognition or sign language translation through posture information are negatively affected. In addition, even for the same words and sentences, there are expressive differences (locations of hand or fingers, facial expression, speed of movement) in the sign language gestures that signers use to express them. Accordingly, in order to improve the performance of sign language gesture recognition or sign language translation through posture information, various sign language gestures are required for the same words and sentences.

### SUMMARY

The disclosure has been developed in order to solve the above-described problems, and an object of the disclosure is to provide a sign language posture information augmentation method, which extracts sign language feature information including physical characteristics and sign language expressive characteristics in sign language gestures, and augments new 3D posture information satisfying the sign language feature information by applying the sign language feature information to a conditional generative model.

According to an embodiment of the disclosure to achieve the above-described object, a sign language posture information augmentation system may include: an output unit configured to predict 3D sign language posture information from a 2D sign language video stored in a first sign language data set with pre-trained networks, and to output the 3D sign language posture information; and an augmentation unit configured to augment 3D posture information based on sign language feature information which is extracted by using information of the first sign language data set and information outputted from the output unit.

The sign language posture information output unit may include: an extractor configured to extract 2D posture information from a 2D sign language video stored in a second sign language data set in which the 2D sign language video comprised of 2D sign language images, time of the 2D sign language video and sign language morphemes corresponding to the time are stored; and a first network configured to predict the 3D posture information from the 2D posture information extracted by the extractor.

The sign language posture information output unit may further include: a second network configured to predict sign language morphemes from the 3D prediction posture information predicted by the first network, and to predict the time that the predicted sign language morphemes appear in the 2D sign language video; and a delivery unit configured to pair the sign language morphemes, the time, and the 3D prediction posture information which are predicted by the first network and the second network, and to deliver the paired information to the augmentation unit.

The delivery unit may deliver the paired information to the augmentation unit only when the sign language morphemes predicted by the second network are identical to the sign language morphemes stored in the second sign language data set.

The augmentation unit may further include: an extraction unit configured to extract sign language feature information by using 3D posture information in each frame, the time of the 2D sign language video and the sign language morphemes corresponding to each time, which are stored in the first sign language data set, and the predicted 3D posture information, the sign language morphemes, the time which are delivered from the delivery unit; and a storage unit configured to store the sign language feature information extracted by the extraction unit.

The sign language feature information may include physical characteristic information, and the physical characteristic information may be information for identifying physical differences in body.

The sign language feature information may include sign language expressive characteristic information, and the sign language expressive characteristic information may be information for identifying differences in expressing sign language.

According to an embodiment, the sign language posture information augmentation system may further include an augmentation network configured to receive the 3D posture information and to augment the 3D posture information by conditionally applying the sign language feature information stored in the storage unit.

The augmentation network may be one of a conditional variational auto-encoder (CVAE) and a stable diffusion model.

According to another aspect of the disclosure, there is provided a sign language posture information augmentation method including: predicting 3D sign language posture information from a 2D sign language video stored in a first sign language data set with pre-trained networks; and augmenting 3D posture information based on sign language feature information which is extracted by using information of the first sign language data set and the predicted information.

According to still another aspect of the disclosure, there is provided a sign language posture information augmentation system including: an extraction unit configured to extract sign language feature information by using 3D posture information in each frame, a time of a 2D sign language video and sign language morphemes corresponding to each time, which are stored in a first sign language data set, and 3D posture information predicted from a 2D sign language video, sign language morphemes, a time which are stored in a second sign language data set; a storage unit configured to store sign language feature information extracted by the extraction unit; and an augmentation unit configured to receive the 3D posture information and to augment the 3D posture information by conditionally applying the sign language feature information stored in the storage unit.

As described above, according to embodiments of the disclosure, by extracting sign language feature information including physical characteristics and sign language expressive characteristics in sign language gestures, and applying the sign language feature information to a conditional generative model, new 3D posture information meeting the sign language feature information may be augmented.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a sign language posture information augmentation system according to an embodiment of the disclosure;

FIG. 2 is a view illustrating a detailed configuration of a network pre-training unit shown in FIG. 1;

FIG. 3 is a view illustrating an example of the entire sign language data sets;

FIG. 4 is a view illustrating a detailed configuration of a sign language posture information output unit shown in FIG. 1;

FIG. 5 is a view illustrating a detailed configuration of a sign language posture information augmentation unit shown in FIG. 1;

FIG. 6 is a view illustrating examples of physical characteristic information and sign language expressive characteristic information; and

FIG. 7 is a view illustrating a sign language posture information augmentation method according to another embodiment of the disclosure.

### DETAILED DESCRIPTION

Hereinafter, the disclosure will be described in more detail with reference to the accompanying drawings.

Embodiments of the disclosure present a sign language posture information augmentation method. The disclosure relates to a technique for extracting sign language feature information including physical characteristics and sign language expressive characteristics in sign language gestures, and augmenting new 3D posture information satisfying the sign language feature information by applying the sign language feature information to a conditional generative model.

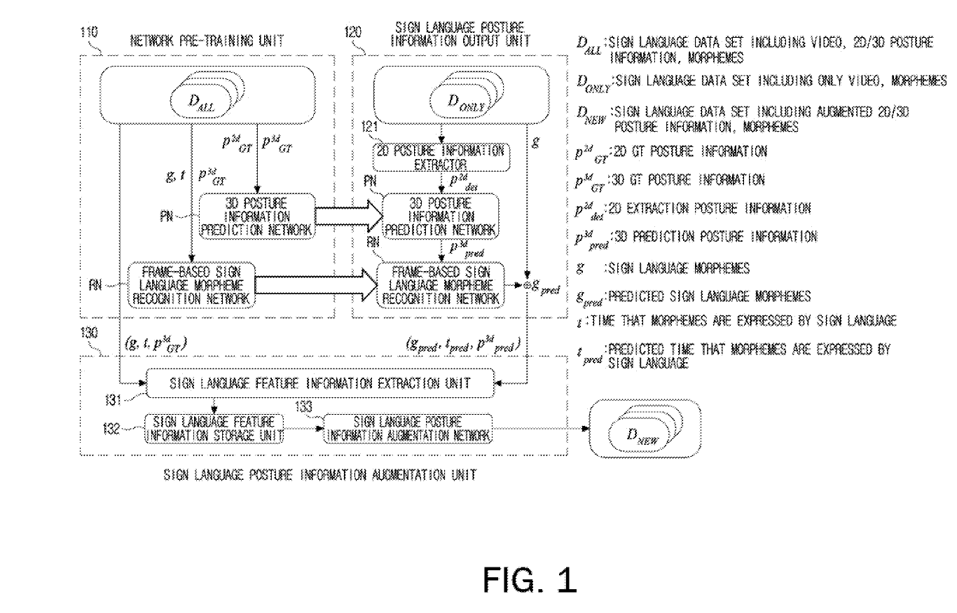

FIG. 1 is a view illustrating a configuration of a sign language posture information augmentation system according to an embodiment of the disclosure. As shown in FIG. 1, the sign language posture information augmentation system according to an embodiment may be configured by including a network pre-training unit 110, a sign language posture information output unit 120, and a sign language posture information augmentation unit 130.

The network pre-training unit 110 may pre-train a 3D posture information prediction network PN and a frame-based sign language morpheme recognition network RN by using entire sign language data sets D_{ALL}.

The sign language posture information output unit 120 may predict 3D sign language posture information from a 2D sign language video that is stored in a partial sign language data set D_{ONLY} with the networks PN, RN pre-trained by the network pre-training unit 110.

The sign language posture information augmentation unit 130 may extract sign language feature information by using the entire sign language data sets D_{ALL} and the information predicted by the sign language posture information output unit 120, and may generate new 3D posture information by augmenting 3D posture information by conditionally applying the extracted sign language feature information.

Hereinafter, the configurations 110, 120, 130 of the sign language posture information augmentation system according to an embodiment will be described in detail one by one.

### 1. Network pre-training unit 110

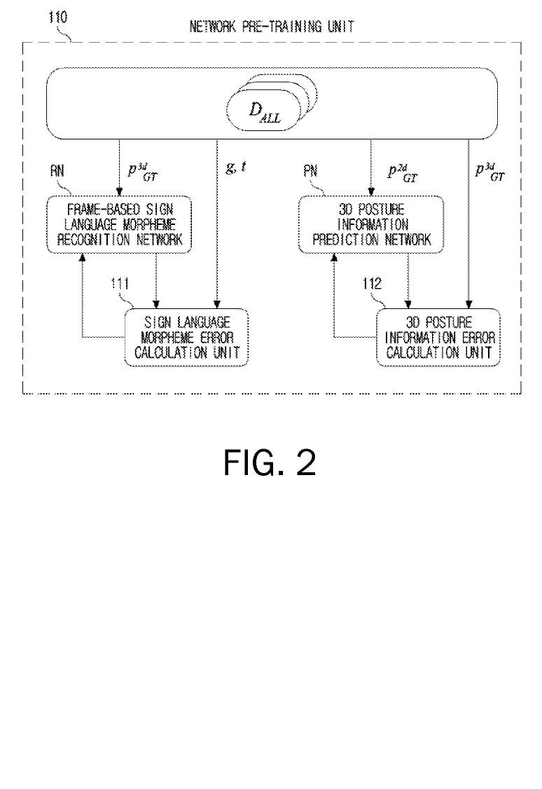

FIG. 2 is a view illustrating a detailed configuration of the network pre-training unit 110 shown in FIG. 1. As shown in FIG. 2, the network pre-training unit 110 may be configured by including the entire sign language data sets D_{ALL}, the frame-based sign language morpheme recognition network RN, the 3D posture information prediction network PN, a sign language morpheme error calculation unit 111, and a 3D posture information error calculation 112.

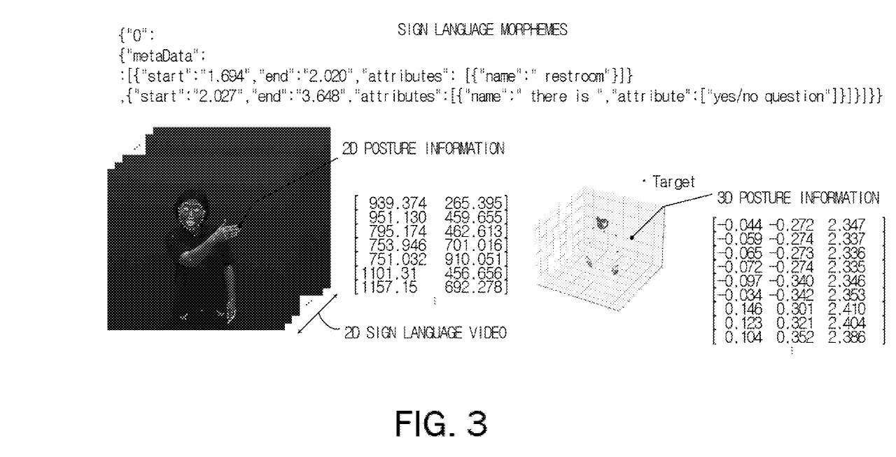

The entire sign language data sets D_{ALL} may store in pairs: 1) a 2D sign language video that is comprised of 2D sign language images of various frames; 2) 2D posture information in each frame; 3) 3D posture information in each frame; and 4) the time of the 2D sign language video and sign language morphemes corresponding thereto. Information constituting the entire sign language data sets D_{ALL} may be expressed as shown in FIG. 3. The time of the 2D sign language video may be expressed by frames.

The 3D posture information prediction network PN is an artificial neural network that predicts 3D posture information from 2D posture information. The 3D posture information error calculation unit 112 may calculate an error between the result of predicting by the 3D posture information prediction network PN and a GT stored in the entire sign language data sets D_{ALL}, and may update the 3D posture information prediction network PN in a way that reduces the error.

The frame-based sign language morpheme recognition network RN is an artificial neural network that predicts sign language morphemes from the 3D posture information, and predicts the time the predicted sign language morphemes appear in the 2D sign language video. The sign language morpheme error calculation unit 111 may calculate an error between the result of predicting by the frame-based sign language morpheme recognition network RN and the GT stored in the entire sign language data sets D_{ALL}, and may update the frame-based sign language morpheme recognition network RN in a way that reduces the error.

### 2. Sign language posture information output unit 120

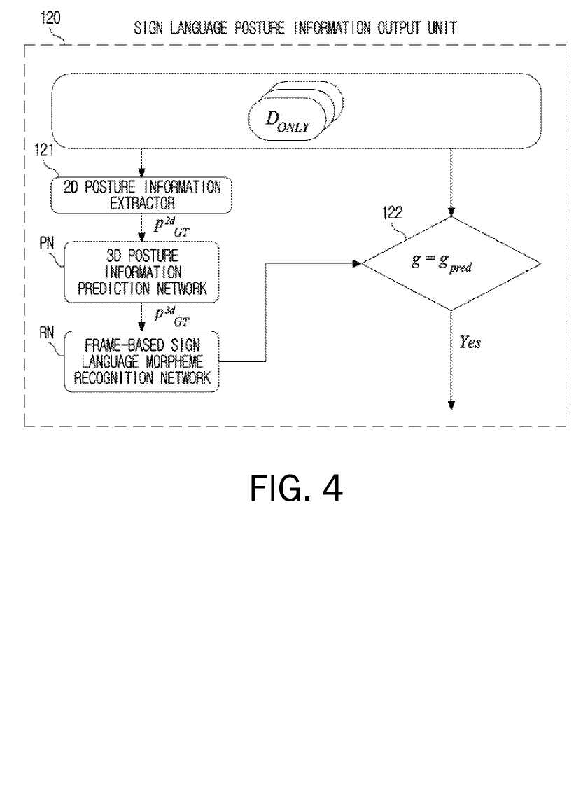

FIG. 4 is a view illustrating a detailed configuration of the sign language posture information output unit 120 shown in FIG. 1. As shown in FIG. 4, the sign language posture information output unit 120 may be configured by including the partial sign language data set D_{ONLY}, a 2D posture information extractor 121, a 3D posture information prediction network PN, a frame-based sign language morpheme recognition network RN, a sign language morpheme comparator 122.

The partial sign language data set D_{ONLY} may only store: 1) a 2D sign language video which is comprised of 2D sign language images of various frames; and 2) the time of the 2D sign language video and sign language morphemes corresponding thereto among pieces of information stored in the entire sign language data sets D_{ALL} described above.

The 2D posture information extractor 121 may extract 2D posture information from the 2D sign language video stored in the partial sign language data set D_{ONLY}. The 2D posture information extractor 121 may be implemented by an artificial neural network that is pre-trained to extract 2D posture information including detailed location information of face and both hands, such as OpenPose, MediaPipe, Sapiens, from a 2D video.

The 3D posture information prediction network PN may predict 3D posture information from the 2D prediction posture information extracted by the 2D posture information extractor 121. The 3D posture information prediction network PN may be pre-trained by the above-described network pre-training unit 110.

The frame-based sign language morpheme recognition network RN may predict sign language morphemes from the 3D prediction posture information outputted from the 3D posture information prediction network PN. In addition, the frame-based sign language morpheme recognition network RN may also predict the time that the predicted sign language morphemes appear in the 2D sign language video. The frame-based sign language morpheme recognition network RN may be pre-trained by the above-described network pre-training unit 110.

The sign language morpheme comparator 122 may identify whether the sign language morphemes predicted by the frame-based sign language morpheme recognition network RN are identical to the sign language morphemes GT stored in the partial sign language dataset D_{ONLY}, and, when they are equal to each other, the sign language morpheme comparator 122 may pair the sign language morphemes predicted by the frame-based sign language morpheme recognition network RN, the predicted time, and the 3D prediction posture information, and may deliver the paired information to the sign language posture information augmentation unit 130.

### 3. Sign language posture information augmentation unit 130.

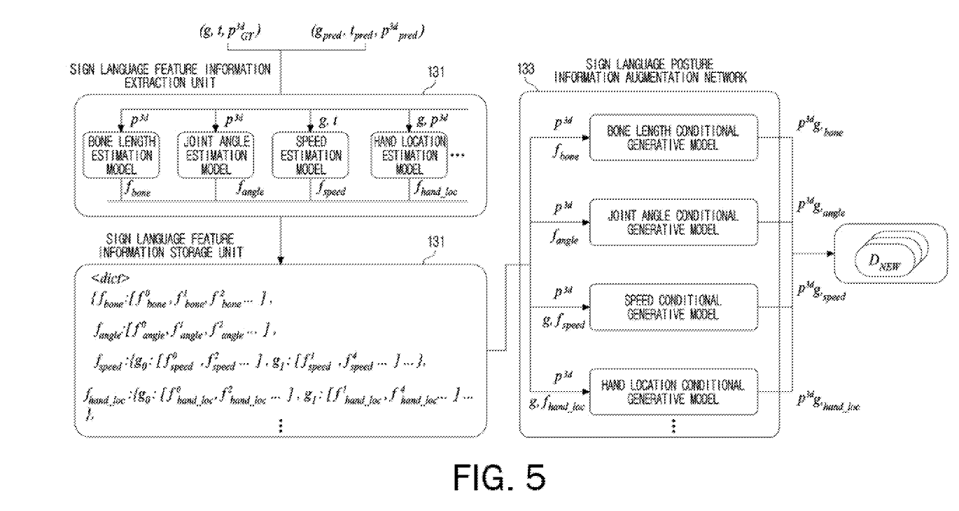

FIG. 5 is a view illustrating a detailed configuration of the sign language posture information augmentation unit 130 shown in FIG. 1. As shown in FIG. 5, the sign language posture information augmentation unit 130 may be configured by including a sign language feature information extraction unit 131, a sign language feature information storage unit 132, and a sign language posture information augmentation network 133.

The sign language feature information extraction unit 131 may extract sign language feature information by using: 1) 3D posture information in each frame, the time of a 2D sign language video and sign language morphemes corresponding thereto, which are stored in the entire sign language data sets D_{ALL} of the network pre-training unit 110; and 2) 3D posture information, sign language morphemes, and time which are predicted by the frame-based sign language morpheme recognition network RN and delivered by the sign language morpheme comparator 122.

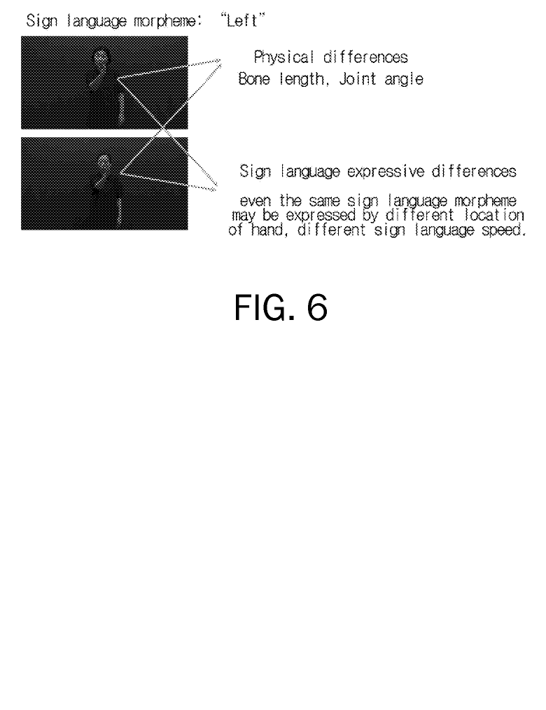

The extracted sign language feature information may be divided into physical characteristic information and sign language expressive characteristic information. FIG. 6 illustrates examples of physical characteristic information and sign language expressive characteristic information. The physical characteristic information may be information for identifying physical differences in the body, such as bone length and joint angle, and the sign language expressive characteristic information may be information for identifying differences in expression of sign language such as sign language speed, location of hand, which are directly related to sign language. The physical characteristic information and the sign language expressive characteristic information may be extracted through an artificial neural network, Euclidean distance calculation, or inner product calculation.

In the sign language feature information storage unit 132, the sign language feature information extracted by the sign language feature information extraction unit 131 may be stored according to characteristics. In this case, the same feature information may be stored altogether, and the sign language expressive characteristic information may be stored in pair with sign language morphemes. The sign language feature information may be stored in the form of a list or dictionary.

The sign language posture information augmentation network 133 may receive 3D posture information and may augment the 3D posture information by conditionally applying the physical characteristic information or sign language expressive characteristic information stored in the sign language feature information storage unit 132. The sign language expressive characteristic information may be conditionally applied with the sign language morphemes. This leads to generation of new 3D posture information.

The sign language posture information augmentation network 133 may be implemented by a deep learning network that imposes conditions such as a conditional variational auto-encoder (CVAE) or a stable diffusion model and configures a potential space meeting the corresponding conditions.

When the 3D posture information is augmented, the 3D posture information may be augmented only through physical changes without relating physical characteristic information, such as bone length and joint angle, to sign language morphemes. In addition, the 3D posture information may be augmented by reflecting expressive changes according to sign language morphemes since the sign language expressive characteristic information, such as sign language speed and hand location, is directly related to sign language morphemes.

New 3D posture information generated through augmentation may be paired with corresponding sign language morphemes and may be stored in a new sign language data set D_{NEW}.

### 4. Sign language posture information augmentation method

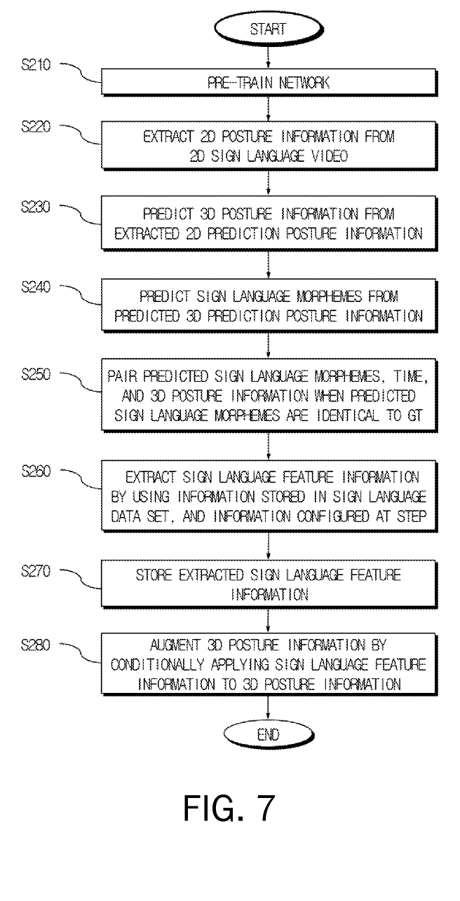

FIG. 7 is a flowchart illustrating a sign language posture information augmentation method according to another embodiment of the disclosure.

To augment sign language posture information, the network pre-training unit 110 may pre-train the 3D posture information prediction network PN and the frame-based sign language morpheme recognition network RN (S210) as shown in FIG. 7.

The 2D posture information extractor 121 of the sign language posture information output unit 120 may extract 2D posture information from a 2D sign language video stored in the partial sign language data set D_{ONLY} (S220), and the 3D posture information prediction network PN may predict 3D posture information from the 2D prediction posture information extracted at step S220 (S230).

The frame-based sign language morpheme recognition network RN may predict sign language morphemes from the 3D prediction posture information predicted at step S230 (S240). When the sign language morphemes predicted at step S240 are identical to sign language morphemes GT stored in the partial sign language data set D_{ONLY}, the sign language morpheme comparator 122 may pair the sign language morphemes precited at step S240, predicted time, and the 3D prediction posture information (S250).

The sign language feature information extraction unit 131 of the sign language posture information augmentation unit 130 may extract sign language feature information by using 3D posture information in each frame, the time of the 2D sign language video and sign language morphemes corresponding thereto, which are stored in the entire sign language data sets D_{ALL}, and the predicted 3D posture information, the sign language morphemes, and the time, which are configured at step S250 (S260).

The sign language feature information storage unit 132 may store the sign language feature information extracted at step S260 (S270), and the sign language posture information augmentation network 133 may receive the 3D posture information, and may augment the 3D posture information by conditionally applying physical characteristic information or sign language expressive characteristics information stored at step S270 (S280).

### 5. Variations

Up to now, the sign language posture information augmentation method using the sign language video and the sign language morphemes has been described in detail with reference to preferred embodiments.

In the above embodiments, by extracting sign language feature information including physical characteristics and sign language expressive characteristics in sign language gestures, and applying the sign language feature information to a conditional generative model, new 3D posture information meeting the sign language feature information may be augmented.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A sign language posture information augmentation system comprising:
an output unit configured to predict 3D sign language posture information from a 2D sign language video stored in a first sign language data set with pre-trained networks, and to output the 3D sign language posture information; and
an augmentation unit configured to augment 3D posture information based on sign language feature information which is extracted by using information of the first sign language data set and information outputted from the output unit.

2. The sign language posture information augmentation system of claim 1, wherein the sign language posture information output unit comprises:
an extractor configured to extract 2D posture information from a 2D sign language video stored in a second sign language data set in which the 2D sign language video comprised of 2D sign language images, time of the 2D sign language video and sign language morphemes corresponding to the time are stored; and
a first network configured to predict the 3D posture information from the 2D posture information extracted by the extractor.

3. The sign language posture information augmentation system of claim 2, wherein the sign language posture information output unit further comprises:
a second network configured to predict sign language morphemes from the 3D prediction posture information predicted by the first network, and to predict the time that the predicted sign language morphemes appear in the 2D sign language video; and
a delivery unit configured to pair the sign language morphemes, the time, and the 3D prediction posture information which are predicted by the first network and the second network, and to deliver the paired information to the augmentation unit.

4. The sign language posture information augmentation system of claim 3, wherein the delivery unit is configured to deliver the paired information to the augmentation unit only when the sign language morphemes predicted by the second network are identical to the sign language morphemes stored in the second sign language data set.

5. The sign language posture information augmentation system of claim 3, wherein the augmentation unit further comprises:
an extraction unit configured to extract sign language feature information by using 3D posture information in each frame, the time of the 2D sign language video and the sign language morphemes corresponding to each time, which are stored in the first sign language data set, and the predicted 3D posture information, the sign language morphemes, the time which are delivered from the delivery unit; and
a storage unit configured to store the sign language feature information extracted by the extraction unit.

6. The sign language posture information augmentation system of claim 5, wherein the sign language feature information comprises physical characteristic information, and
wherein the physical characteristic information is information for identifying physical differences in body.

7. The sign language posture information augmentation system of claim 6, wherein the sign language feature information comprises sign language expressive characteristic information, and
wherein the sign language expressive characteristic information is information for identifying differences in expressing sign language.

8. The sign language posture information augmentation system of claim 5, further comprising an augmentation network configured to receive the 3D posture information and to augment the 3D posture information by conditionally applying the sign language feature information stored in the storage unit.

9. The sign language posture information augmentation system of claim 8, wherein the augmentation network is one of a conditional variational auto-encoder (CVAE) and a stable diffusion model.

10. A sign language posture information augmentation method comprising:
predicting 3D sign language posture information from a 2D sign language video stored in a first sign language data set with pre-trained networks; and
augmenting 3D posture information based on sign language feature information which is extracted by using information of the first sign language data set and the predicted information.

11. A sign language posture information augmentation system comprising:
an extraction unit configured to extract sign language feature information by using 3D posture information in each frame, a time of a 2D sign language video and sign language morphemes corresponding to each time, which are stored in a first sign language data set, and 3D posture information predicted from a 2D sign language video, sign language morphemes, a time which are stored in a second sign language data set;
a storage unit configured to store sign language feature information extracted by the extraction unit; and
an augmentation unit configured to receive the 3D posture information and to augment the 3D posture information by conditionally applying the sign language feature information stored in the storage unit.
